(19) United States
(12) Patent Application Publication
(10) Pub. No.: US 2017/0360255 A1
(43) Pub. Date: Dec. 21, 2017

(54) APPARATUS FOR TEMPERATURE CONTROL OF BARBECUE OVEN

(71) Applicant: KBQ Technologies, LLC, Southlake, TX (US)

(72) Inventor: William H. Karau, Southlake, TX (US)

(21) Appl. No.: 15/627,319

(22) Filed: Jun. 19, 2017

Related U.S. Application Data
(60) Provisional application No. 62/351,788, filed on Jun. 17, 2016.

(51) Int. Cl. A47J 37/07

(52) U.S. Cl. CPC A47J 37/0754; A47J 37/0704; A47J 37/0786

(57) ABSTRACT

An apparatus for temperature control of a barbecue oven, in accordance with an exemplary embodiment of the present disclosure. A vent from a firebox feeds heated air with smoke to a cook box. A variable speed motor connected to a blower wheel draws air out of the cook box into a plenum, and also pressurizes the plenum to force air back onto the cook box through one or more vents between the plenum and the cook box, as well as out of the stack. A variable frequency drive is coupled to the variable speed motor and a proportional-integral-derivative (PID) controller, which is coupled to a temperature sensor. When the temperature falls below a set point, the PID controller causes the variable frequency drive to actuate the variable speed motor and draw heated air into the cook box from the firebox. The blower wheel and vents circulate the heated air in the cook box, and the air exhaust through the stack allows heated air to be drawn into the cook box.

### RELATED APPLICATIONS

The present application claims benefit of and priority to U.S. Provisional Patent Application No. 62/351,788, filed Jun. 17, 2016, entitled “APPARATUS FOR TEMPERATURE CONTROL OF BARBECUE OVEN,” which is hereby incorporated by reference for all purposes as if set forth herein in its entirety.

### TECHNICAL FIELD

The present disclosure relates generally to cooking equipment, and more specifically to an apparatus for temperature control of a barbecue oven that results in more efficient control of temperature.

### BACKGROUND OF THE INVENTION

Control of temperature of cooking devices is known, but such general controls fail to be applicable to every configuration of cooking devices.

### SUMMARY OF THE INVENTION

An apparatus for temperature control of a barbeque oven is disclosed that provides for improved temperature control and energy efficiency.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of an apparatus 100 for temperature control of a barbecue oven, in accordance with an exemplary embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

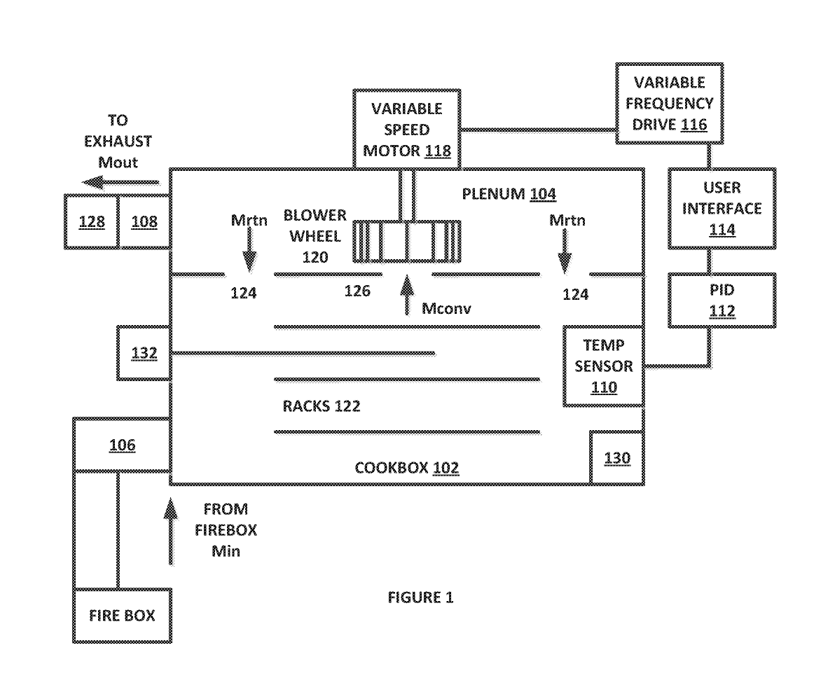

FIG. 1 is a diagram of an apparatus 100 for temperature control of a barbecue oven, in accordance with an exemplary embodiment of the present disclosure. A vent 106 from a firebox feeds heated air with smoke to a cook box 102. In one exemplary embodiment, the heated air with smoke can be obtained from firebox, such as that disclosed in U.S. Pat. No. 8,635,947, “Barbecue firebox and method of operation,” or U.S. Pat. No. 9,526,376, “Barbecue oven and method of operation,” both of which are hereby incorporated by reference for all purposes as if set forth in their entirety. A variable speed motor 118 connected to a blower wheel 120 draws air out of the cook box 102 into a plenum 104 through vent 126, and also pressurizes the plenum 104 to force air back onto the cook box 102 through one or more vents 124 between the plenum and the cook box, as well as out of the stack. A variable frequency drive 116 is coupled to the variable speed motor 118 and a proportional-integral-derivative (PID) controller 112, which is coupled to a temperature sensor 110. When the temperature falls below a set point, the PID controller 112 causes the variable frequency drive 116 to actuate the variable speed motor 118 and draw heated air into the cook box 102 from the firebox. The blower wheel 120 and vents 124 and 126 circulate the heated air in the cook box 102, and the air exhaust through the stack 108 allows heated air to be drawn into the cook box 102. A user interface 114 can be coupled to one or more of PID controller 112, variable frequency drive 116 and variable speed motor 118, either as shown or in other suitable manners, and can be used to control a temperature set point of operation for the cook box 102. PIC controller 112, user interface 114, variable frequency drive 116 and variable speed motor 118 can be implemented in hardware (such as by using analog devices that are coupled to each other using analog electrical connectors or mechanical connectors) or a suitable combination of hardware and software (such as by using analog devices with digital controls).

In one exemplary embodiment, PID controller 112 can be implemented as a proportional only controller, a proportional-integral only controller or other suitable controllers that are operable to maintain the temperature within the cook box 102 at a predetermined set point and within a predetermined accuracy. While an on/off switch or other such devices could be used, those devices will intermittently stop all circulation, which is not desirable, and will require constant manual interaction to maintain the temperature within the cook box 102 at a predetermined level within a desired level of accuracy.

In addition, to the disclosed embodiments shown in FIG. 1, an adjustable damper, back-pressure or exhaust rain cap flapper regulating damper (128) can be coupled to the exhaust 108 or a smoke stack coupled to the exhaust 108. Likewise, a grease drain 130 can be coupled to the bottom of cook box 102, and can be configured with a valve or trap to prevent back flow of air during operation. A rotisserie 132 or other suitable device can also be coupled to the space inside of cook box 102, such as by mounting a motor drive external to cook box 102 with a bearing or other suitable torque-transmission device to drive the rotisserie.

The flow rate into the cook box 102 Mᵢₙ, and the flow rate out of the cook box Mₒᵤₜ must generally be equal. The flow rate returning to the cook box 102 from the plenum 104 Mᵣₜₙ must generally equal the flow rate through the blower wheel M_{conv} minus the flow rate out of the cook box Mₒᵤₜ.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other si table data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. An apparatus for temperature control of a barbecue oven, comprising:
an intake vent from a firebox configured to feed heated air with smoke to a cook box;
a variable speed motor connected to a blower wheel and configured to draw air out of the cook box into a plenum, and also to pressurize the plenum to force air back onto the cook box through one or more vents between the plenum and the cook box, as well as out of an exhaust vent;
a variable frequency drive coupled to the variable speed motor and a controller, which is coupled to a temperature sensor;
wherein when a temperature measured by the temperature sensor falls below a set point, the controller causes the variable frequency drive to actuate the variable speed motor to draw heated air into the cook box from the firebox, to circulate the heated air in the cook box, and to exhaust hot air from an exhaust vent to cause additional heated air to be drawn into the cook box.

2. The apparatus of claim 1 wherein the controller comprises a proportional-integral-derivative (PIP) controller.

3. The apparatus of claim 1 wherein the controller comprises a proportional-integral (PI) controller.

4. The apparatus of claim 1 further comprising an adjustable damper coupled to the exhaust vent.

5. The apparatus of claim 1 further comprising a back-pressure regulating damper coupled to the exhaust vent.

6. The apparatus of claim 1 further comprising an exhaust rain cap flapper coupled to the exhaust vent.

7. The apparatus of claim 1 further comprising a grease drain coupled to the cook box, wherein the grease drain is configured with a valve or trap to prevent back flow of air du ring operation.

8. The apparatus of claim 1 further comprising a rotisserie coupled to the cook box.

9. The apparatus of claim 1 wherein the blower wheel is located over a central plenum intake vent.

10. The apparatus of claim 1 wherein the blower wheel is located adjacent to a plenum exhaust vent.

11. The apparatus of claim 1 wherein the blower wheel is located adjacent to a plurality of plenum exhaust vents.

12. The apparatus of claim 1 wherein the plenum is located over the cook box.

13. The apparatus of claim 1 further comprising a plurality of racks disposed within the cook box.
